(19) United States
(12) Patent Application Publication
(10) Pub. No.: US 2010/0170958 A1
(43) Pub. Date: Jul. 8, 2010

(54) HURRICANE MITIGATION BY COMBINED SEEDING WITH CONDENSATION AND FREEZING NUCLEI

(75) Inventors: Daniel Rosenfeld, Jerusalem (IL); Alexander Khain, Jerusalem (IL); William Woodley, Littleton, CO (US)

Correspondence Address: LAW OFFICES OF KHALILIAN SIRA, LLC, 9100 PERSIMMON TREE ROAD, POTOMAC, MD, 20854, US

(73) Assignee: Yissum Research Development Company of the Hebrew University of Jerusalem, Ltd., Jerusalem (IL)

(21) Appl. No.: 12/518,987

(22) PCT Filed: Dec. 11, 2007
(86) PCT No.: PCT/IL2007/001524

§ 371 Date: Feb. 10, 2010

Related U.S. Application Data
(60) Provisional application No. 60/869,698, filed on Dec. 12, 2006.

(51) Int. Cl. A01G 15/00

(52) U.S. Cl. 239/2.1

(57) ABSTRACT

The invention provides method for treating a tropical cyclone, a tropical storm or a tropical depression. The method includes reducing unloading of cloud parcel water in the tropical cyclone, tropical storm or tropical depression. In a preferred embodiment, unloading of cloud parcel water is accomplished by seeding with cloud condensation nuclei, such as sub-micron ammonium sulfate particles. The treatment is preferably applied to the lower parts of peripheral clouds in the tropical cyclone, tropical storm or tropical depression below the 0 C isotherm level.

### FIELD OF THE INVENTION

This invention relates to methods for reducing the intensity of a hurricane

### BACKGROUND OF THE INVENTION

The devastating United States hurricane season of 2005 renewed interest in developing methods to mitigate the strong winds of hurricanes. Since a hurricane's destructive potential increases with the cube of its strongest winds, a reduction as small as 10% in its wind speed would be beneficial. Hurricane modification involves intervening in the energy pathways in the moist tropical convective clouds that energize the hurricane. The energy pathways in a hurricane are depicted in FIG. 1. These energy pathways take heat from the sea surface mainly by evaporation (A). This latent heat is observed as vapor condensation into cloud drops (B). Some of this heat is reclaimed if the drops re-evaporate (C), but the heat remains in the air if the drops precipitate as rain (D). Drops that ascend into the sub-zero portion of the cloud freeze, and release additional latent heat of freezing (E), which along with the freezing of the ascending vapor, warm the upper levels of the cloud (G). Some of the heat is lost when ice evaporates in the sub-zero portion (I). The rest of the heat remains in the cloud when the ice hydrometeors precipitate and melt while cooling the air below (H).

U.S. Pat. No. 5,441,200 to Rovella, II discloses application of a chemical to the eye wall of a tropical cyclone to initiate a self destructive catalyzing effect, where the chemical allows water to chemically join its crystalline lattice. If applied in powdered form to the upper, center portions of the eye wall, the effect is greater. Water vapor within the eye wall chemically joins the lattice of the chemical. These larger molecules will also develop through collision and coalesce. The vapor of the eye wall thus becomes heavier and spins outwards due to centrifugal force. As a result of the larger eye, barometric pressure in the eye increases, wind speed slows, and the storm surge decreases to minimal proportions.

Hurricane mitigation was attempted in the framework of project STORMFURY by the US government (Willoughby et al., 1985). Project STORMFURY was an experimental program of research on hurricane modification carried out between 1962 and 1983 which attempted to develop hurricane mitigation techniques. The techniques involved artificial stimulation of convection outside the hurricane eyewall through seeding with silver iodide in order to freeze super-cooled water (liquid water below 0° C.) to release additional latent heat of freezing. The invigorated convection induced by the extra heating was predicted to compete with the original eyewall, leading to reformation of the eyewall at a larger radius, and thus, through partial conservation of angular momentum, produce a decrease in the strongest winds.

The STORMFURY technique was applied in four hurricanes on eight different days. On four of these days, the winds decreased by between 10 and 30%. The lack of response on the other days was interpreted to be the result of faulty execution of the seeding or of poorly selected subject hurricanes. However, in the mid-1980s it became clear from observations in unmodified hurricanes that hurricanes contain insufficient super-cooled water available for freezing in the clouds due to premature rainout for the seeding to be effective. It was then suggested that the positive results of the seeding experiments in the 1960s stemmed from an inability to distinguish between the results of human intervention and the natural behavior of hurricanes.

Cloud drops are formed on pre-existing aerosol particles in the cooled ascending air streams. The pre-existing aerosol particles are referred to as “cloud condensation nuclei” (CCN). When the air contains a high concentration of CCN, the cloud water is divided into a large number of small water drops, which float in the air and which are too small to combine into rain drops. In contrast, large cloud drops form when CCN are scarce. The large drops have a relatively large fall velocity and collide with each other to coalesce quickly into raindrops that precipitate from the cloud. Rosenfeld (1999) showed that smoke from forest fires can suppress rainfall in tropical clouds in Indonesia. Andreae et al. (2004) and Freud et al. (2005) used in-cloud aircraft measurements and quantified the CCN dependence of the cloud depth for the onset of precipitation in the Amazon. Andreae et al. (2004) measured the cloud drop size distribution with height using aircraft in four cases having different concentrations of CCN. In all four cases, the drop size was found to increase with height above cloud base, but it did so most rapidly in the cleanest air and most slowly in the air having the largest concentration of CCN in the form of heavy smoke. Model simulations of ascending cloud parcels with different concentrations of small CCN also showed that increasing concentrations of small CCN increases the height above cloud depth that is required for the onset of rainfall (Segal et al., 2004).

Weakening of winds is known to occur along with increasing lightning activity in the outer cloud bands of hurricanes ingesting CCN rich air (Shao et al., 2005). Nong and Emanuel (2003) showed that low level air with enhanced buoyancy tends to rise before reaching the eyewall and initiate the process of an eyewall replacement with a larger eye.

Independent measurements done in winter clouds in California (Rosenfeld, 2006) show a very similar dependence in spite of the very different meteorological conditions. A concentration of 1500 CCN cm⁻³ is required to delay the onset of rain to a height of 5000 m. At this height the temperatures is sub-freezing even under the warmest conditions in the tropics. The CCN aerosols should be such that they are activated into cloud drops at the available super saturations in the maritime cloud base.

A diameter of 0.1 micrometer would suffice for a CCN particle composition of a sulphur-containing aerosol such as an aerosol of ammonium sulfate to nucleate cloud drops already at the very modest super-saturation of 0.1% (a relative humidity of 100.1%), which is exceeded by actual values in typical cloud bases.

A parcel of cloudy air ascends if it is more buoyant than the ambient air. The buoyancy is defined as:

B=[(T′−T)/T]−x (1)

where B is the buoyancy, T′ is the temperature of the cloud parcel, T is the temperature of the ambient air at the same height, and x is the load of the condensates (cloud drops, ice and precipitation), in units of mixing ratio, i.e, kg of condensates per kg of cloudy air. The vertical acceleration of the parcel is given by gB, where g is acceleration due to gravity of about 10 ms⁻².

The cloud parcel cools as it ascends and hence can hold less water in the form of vapour, which must condense and add to condensate loading if not precipitated immediately.

The variation in the cooling rate with the height of the cloudy parcel and the ambient air mass determines the propensity of convection currents to develop in the cloud. When the ambient lapse rate of the temperature cools with height faster than the cloud parcel, the cloud will become warmer than the ambient air as it rises, and the atmosphere is said to be unstable. When the opposite occurs the atmosphere is stable and provides no support for development of convective clouds. When the atmosphere cools with height at exactly the same rate as the cloud, it is said to be neutral.

According to some studies, the tropical maritime atmosphere is very nearly neutral in stability when including the condensate loading in an undiluted adiabatic parcel (Betts, 1982; Xu and Emanuel, 1989). This means that tropical maritime clouds did lose their condensate loading while growing they would not be able to develop in the typical atmosphere, which is the atmosphere that supports the development of hurricanes. Therefore, tropical maritime clouds, including those in hurricanes, lose their water while growing. Thus, as the air ascends, either much of the condensed cloud water falls down as rainfall, or the cloud is rained out while growing. For the rain to fall through the cloud, the updraft velocity must not exceed the fall velocity of the rain drops, which is about 9 ms⁻¹ for the largest raindrops. Not surprisingly, updraft velocities in tropical maritime clouds below the 0° C. isotherm level rarely exceed 7 ms⁻¹ (Lucas and Zipser, 1994).

The updrafts in maritime clouds below the 0° C. level are too weak to carry the warm rain drops up to the super-cooled zone (i.e., to the zone where the temperature is below 0° C., but where the water can remain in a liquid state; the coldest that cloud water can get before freezing unconditionally is approximately −37.5° C., Rosenfeld and Woodley, 2000). Therefore, much of the cloud water is depleted by raining out before reaching the super-cooled levels (Petersen and Rutledge, 1996; Zipser and Lutz, 1994). This situation leads to the commonly observed conditions in maritime tropical convective clouds of a low super-cooled liquid water content, high concentrations of small ice particles (<0.5 mm), and near absence of large ice particles (>1 mm) (Black and Hallett, 1986; Zipser and Lemone, 1980; Lucas and Zipser, 1994).

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows the energy pathways in the convective clouds that energize hurricanes;

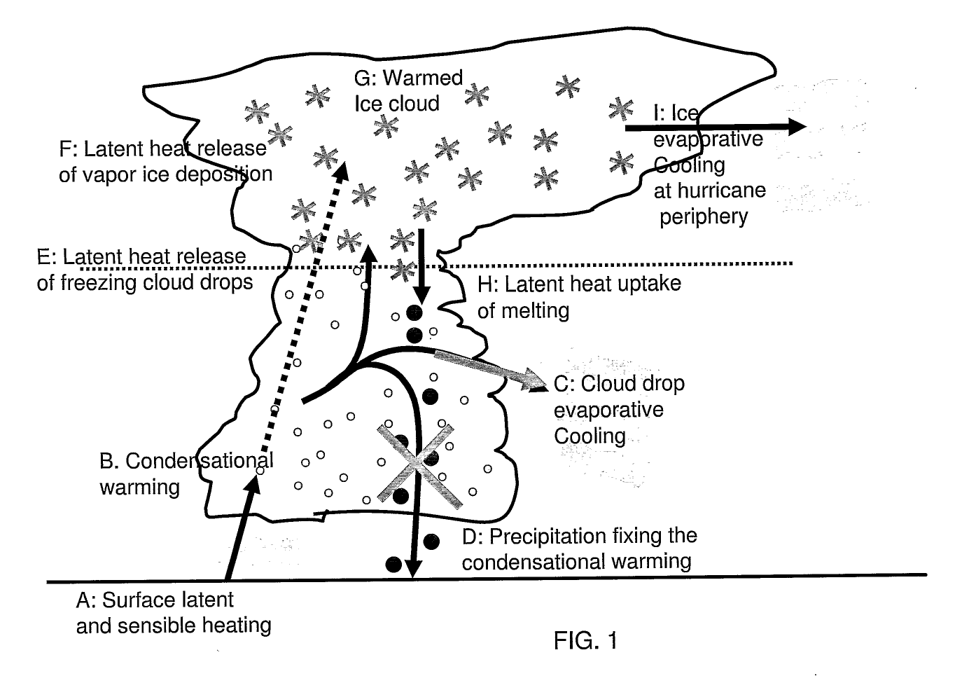

FIG. 2 shows an example for a track (10) that can be flown by several seeder airplanes, seeding the air that flows and feed the convection in the origin of the spiral bands;

FIG. 3 shows the buoyancy of an unmixed adiabatically raising air parcel as a function of decreasing temperature for ascending cloud parcels under various scenarios;

FIG. 4 shows simulated radar reflectivity fields at different time instances; and

FIG. 5 shows that suppression of warm rain causes low level cooling that weakens the storm.

### DESCRIPTION OF THE INVENTION

As used in the following description, the term “tropical cyclone” is used to refer to wind storms having wind velocity of over 32 meters/sec as well as to the embryonic form of such wind storms, which are sometimes referred to as “tropical depressions”, and the intermediate stage which is known as a “tropical storm”. Tropical cyclones are also known as “hurricanes”, “typhoons” and “cyclones” in different parts of the world.

The present invention provides a method for altering a tropical cyclone. A tropical cyclone to be altered is subjected to a treatment that reduces or prevents unloading of the cloud parcel water until the cloud parcel reaches an altitude having a predetermined temperature that is below 0° C. By delaying raining until the cloud parcel reaches the predetermined temperature level, much super-cooled water is accumulated in the mature stage that produces hail, strong precipitation and downdraft in the dissipating stage. The gust front can be sufficiently strong to trigger the next generation of convective clouds and so on, leading to the formation and propagation of a squall line in clouds that are not embedded in a tropical cyclone. At the same time, the lack of precipitation from the lower part of the tropical cyclone clouds causes partial re-evaporation of cloud water that causes cooling of the low levels of the storm, and thus weakens it. The load of the added cloud water further acts to decrease the buoyancy of the low level air and weaken the storm.

In a preferred embodiment, the predetermined temperature is −5° C.

In a preferred embodiment of the invention, treatment that reduces or prevents unloading of the cloud parcel comprises seeding the tropical cyclone with CCN. A large range of materials that can be produced by a large variety of methods can be used for creating the CCN aerosols as disclosed in Dusek et al. (2006). The CCN used for seeding in accordance with this embodiment may be any kind of CCN known in the art.

For example, the CCN may be smoke particles. Dusek et al. (2006) demonstrated that most aerosols produce cloud drops at normal conditions when the aerosols reach the size of 100 nanometers. In a preferred embodiment, the tropical cyclone is seeded with ammonium sulfate particles which are known to be efficient CCN at a diameter of 60 nm.

Seeding 1 kg of hygroscopic particles having diameter of 0.1 μm and density of 2000 kg m⁻³ can fill homogeneously 1 km³ with a concentration of nearly 1000 particles cm⁻³. If the seeding is applied around the storm into the converging marine boundary layer that feeds the storm clouds, the seeding rate should preferably be matched to the influx rate. For example, with average inward radial winds of 5 ms⁻¹ at the 0.6 km deep boundary layer along the nearly 2000 km circumference of the radial distance of 300 km, the influx is about 60 km³ s⁻¹. This corresponds to a seeding rate of 60 kg s⁻¹, or 216 ton per hour. This is practical with large cargo airplanes having payloads exceeding 100 tons.

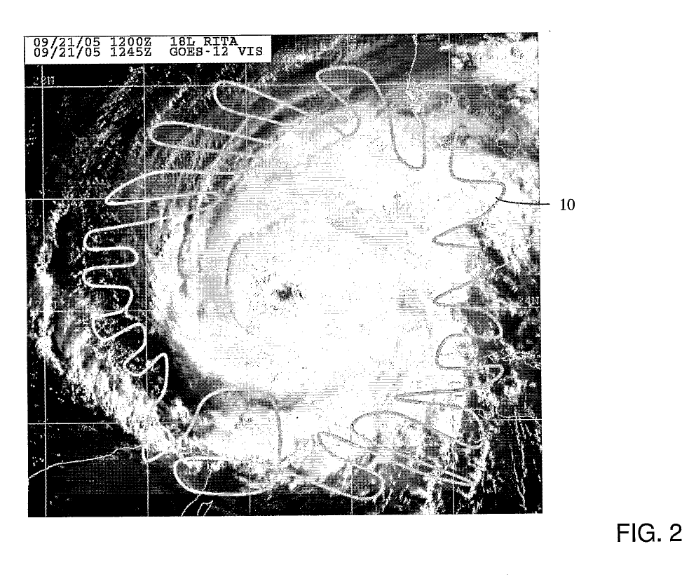

Seeding the full depth of the marine boundary layer with sub-micron sized particles, such as 0.1 μm hygroscopic particles, at concentrations of several thousands particles cm⁻³ can be done, for example, by dispersing hygroscopic smoke from 5 to 10 cargo airplanes flying in the boundary layer just outside the storm's spiral cloud bands so that the particles are drawn into the storm by the low level convergence after having sufficient time to adequately mix in the boundary layer. This can be sufficient for a logistically manageable number of airplanes. FIG. 2 shows an example for a track (10) that can be flown by several seeder airplanes seeding the air that flows and feeds the convection in the origin of the spiral bands. For better dispersion, it is preferable to use a larger number of airplanes with a smaller dispersion rate. About 5 to 10 airplanes on the seeding lines can cover the seeding of a tropical cyclone such as the tropical cyclone shown in FIG. 2. FIG. 2 shows that invigorating the convection earlier in the main spiral band that whirls into the center of the tropical cyclone can rob much of its energy before it reaches the eye wall.

The seeding agent can be carried in liquid form by air to air refueling tankers that burn the seeding agent into smoke that constitutes the CCN. The combustion of the seeding agent can be done in the aircraft jet engines or in their exhaust. In this case, components from the aircraft fuel and/or oxygen from the ambient air may be utilized so that the mass of the released aerosols exceeds the mass of the seeding agent.

Other methods for dispersing CCN aerosols may also be used in the invention.

The CCN seeding should preferably be aimed at the air mass from which the spiral bands of the tropical cyclone feed, and should include at least the full depth of the marine boundary layer (about the lowest 1-km of the atmosphere). The seeding can be done while flying in the lowest kilometer of the storm, preferably at a height of about 1000 feet above the sea surface in the cloud and rain free air, where the wind velocity is below 20 meters/sec, well upstream of the location where that air is ingested into the convective spiral bands. That air mass should be seeded with concentrations that are preferably over 1000 CCN cm⁻³, and more preferably over 2000 CCN cm⁻³. This requires flying a distance of tens to a few hundred km in the clear air upwind of the locations where the deep convective tropical cyclone clouds form, for allowing a good dispersion of the seeded particles in the air mass.

In a most preferred embodiment of the invention, after the cloud parcel has reached the predetermined temperature level, the tropical cyclone is seeded with ice nuclei (IN) in order to freeze super-cooled water (liquid water below 0° C.) to release additional latent heat of freezing. Ice nuclei can be seeded using any seeding technology, such as acetone burners or flares. In a preferred embodiment of the invention silver iodide is used as IN. The preferred concentrations are 1-50 IN liter⁻¹, more preferable 15-25 IN liter⁻¹, and active at about −6° C. to −8° C. Such concentrations are lower by a factor of about 10⁵ than the CCN concentration, and should not pose any logistical problems. The seeding of CCN and IN can be done from the same airplanes.

Instrumented aircraft with cloud physics probes may be used to monitor the aerosol concentrations and the vertical evolution of cloud drop size distributions in the seeded clouds, to verify that most cloud water is retained up to the freezing level and there freezes before precipitated back to the surface. Satellite multi-spectral analyses may be used to monitor cloud composition and provide real time feedback on the effectiveness of the cloud seeding. Satellite technology can determine the effective radius of the CCN seeding and to assess the overall impact on the storm microstructure and efficiency of the seeding. For example, the satellite technology disclosed in Rosenfeld and Lensky (Rosenfeld and Lensky, 1998) may be used.

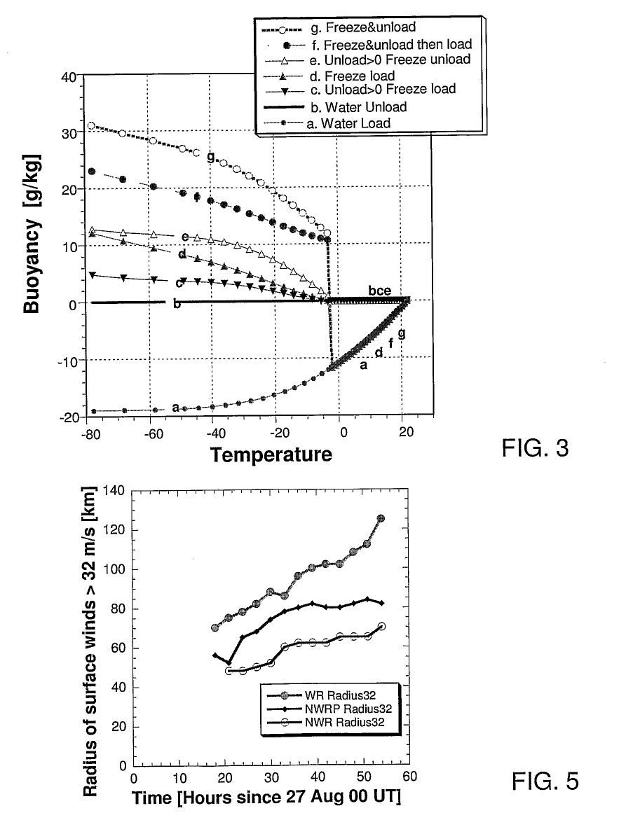

The CCN concentration can determine whether or not rainout will occur, and the IN concentration can determine whether the cloud water that makes it above the 0° C. level (an altitude of 4.5 to 5 km in the tropics) freezes or continues to rise unfrozen to altitudes as high as the −37° C. level, which is at about 10 km above sea level. FIG. 3 depicts the buoyancy of an unmixed adiabatically raising air parcel [g kg⁻¹] with respect to liquid water saturation and unloading of condensates (Buoyancy=0 for all temperatures), with cloud base at 22° C. and 960 mb, under the following scenarios: (a) keeping all water load, no freezing; (b) unloading all water condensates, no freezing; (c) unloading all water condensates at T>−5° C., keeping all condensates as ice at T<−5° C.; (d) keeping all condensates load, freezing at T=−5° C. and keep the ice load; (e) unload all condensates, freezing at T<−5° C. and unload the ice; (f) keeping all water load up to T=−5° C., freezing at that level and unloading the ice, but keeping all ice condensates above that; (g) keeping all water load up to T=−5° C., freezing at that level unloading all ice condensates above that.

A calculation of how these various scenarios can affect the buoyancy of the rising cloud parcel is given below:

In a neutral tropical maritime atmosphere the vertical lapse rate of the temperature of the ambient air is identical to that of a rising cloud parcel under the following conditions:
a. All the excess water vapor condenses only to cloud water, even at sub-zero temperatures.
b. All the condensed water is eliminated from the cloud water immediately, so that the condensate loading is zero.
c. The cloud base temperature is 22° C. and pressure is 960 hPa. This determines a water vapor mixing ratio of 19 g kg⁻¹ just below the cloud base.

The buoyancy of such a cloud parcel would then be exactly zero for all heights or temperatures. This is denoted by the horizontal line of zero b in FIG. 3, which describes the buoyancy as a function of decreasing temperature for ascending cloud parcels under various scenarios.

In the case of keeping all the condensates as cloud water, all of the vapor mixing ratio of 19 g kg⁻¹ at cloud base is converted into the same amount of cloud water at the coldest temperature, where practically all of the vapor is condensed. All of the condensed water provides a negative buoyancy of 19 g kg⁻¹, which is equivalent to a thermal negative buoyancy of 4° K. at the −60° C. level. The negative buoyancy accumulates to −12 g kg⁻¹ at the −5° C. isotherm level, which is equivalent to a negative thermal buoyancy of 3.2° K. In order for the cloud to grow, it has to unload its condensate load early and take the path of line a.

When the water is made to freeze at the predetermined temperature by ice nuclei seeding, the released latent heat of freezing elevates the temperature of the air, which generates sufficient thermal buoyancy to neutralize the condensate loading. Freezing of the added condensates at greater altitudes while keeping the condensates in the raising parcel releases excess heat that generates some positive buoyancy. In a preferred embodiment, the predetermined temperature is −5° C. This scenario is depicted by line c of FIG. 3.

The freezing of such a large amount of super-cooled water is expected to quickly create large ice hydrometeors such as small hailstones that can fall quickly from the cloud volume. In the case when all of the cloud water is first frozen and then unloaded, the negative buoyancy of the cloud water will first be neutralized by the released latent heat of freezing. With the unloading, the remaining thermal buoyancy will no longer be neutralized by condensate loading, resulting in a very buoyant cloud parcel. This scenario is depicted in lines f and g of FIG. 3. Maximal buoyancy will be achieved when following this scenario if the added ice condensates in the rising parcel are unloaded as soon as they condense (line g). This scenario eventually produces a positive buoyancy of 31 g kg⁻¹ at the cloud top, which translates to a thermal buoyancy of 6° K. Scenario f, where all ice condensates are kept in the parcel still gives at cloud top a buoyancy of 23 g kg⁻¹.

Thus, changing the aerosols can change completely the dynamic of the storm. The drops become so small that they rise with the air and do not merge into raindrops before reaching with the rising cloud air the 0° C. isotherm altitude, where they become super-cooled water. The freezing of that super-cooled water releases latent heat that invigorates the clouds. Furthermore, the cloud drops freeze to ice precipitation (including hail) that falls and melts at the low levels while taking the same amount of heat of freezing that was released aloft. This means a greater upward transfer of heat for the same amount of precipitation. Fundamentally, convective motions in the atmosphere arise from static instability, where potential gravitational energy is converted into kinetic energy of the vertical air motions in the clouds. Transferring more heat upwards means converting more gravitational energy into kinetic energy that further invigorates the clouds.

There is little concern that seeding material that reaches the eyewall would invigorate the tropical cyclone. The sea heavy spray that is raised with the strong tropical cyclone winds is carried into the clouds and can jump-start the rain processes even if the cloud drops are small. However, this heavy sea spray that could neutralize the effect of the CCN seeding is not yet developed to that extent at the fringes of the tropical cyclone where the seeding is carried out. This situation helps focusing the seeding effects to where it is intended. This effect was detected with the satellite based methodology developed by Rosenfeld and Lensky (Rosenfeld and Lensky, 1998) to observe cloud drop size and precipitation processes in clouds.

The invention thus provides a method for treating a tropical cyclone, a tropical storm or a tropical depression comprising reducing unloading of cloud parcel water in at least a first portion of the tropical cyclone, tropical storm or a tropical depression.

### EXAMPLES

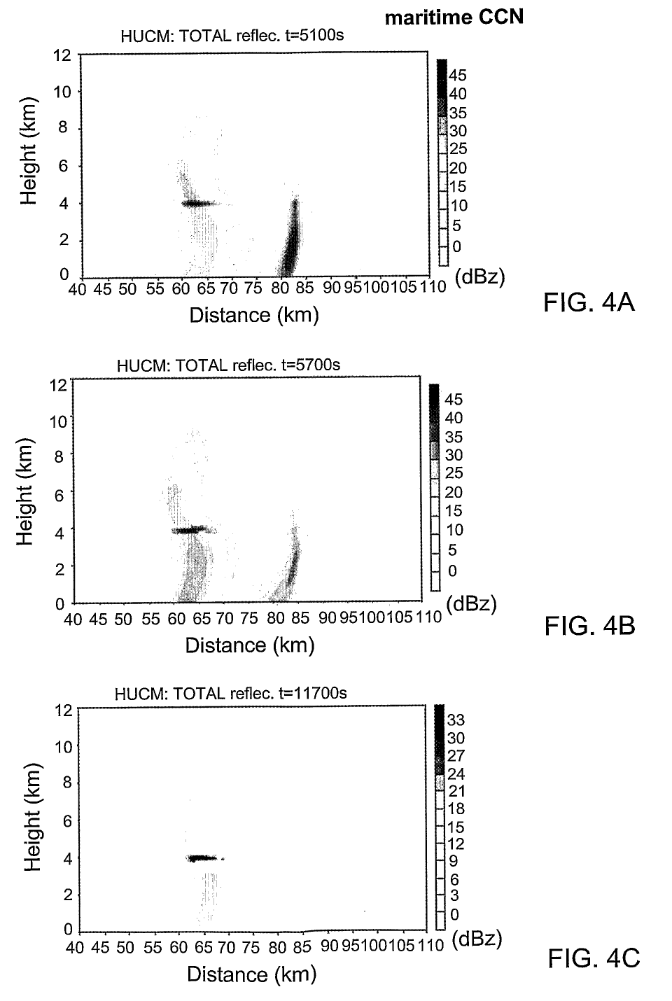

The method of the invention was simulated using the Hebrew University Cloud model (Khain et al., 2005). FIG. 4 shows radar precipitation reflectivity fields at different times (5100 sec (panels a,d), 5700 sec (panels b,e) and 11700 sec (panels c,f)) in simulations of clouds in clean (maritime) atmosphere (low aerosol concentration, (panels a,b,c,) and with high aerosol concentration typical of continental air (panels d,e,f). The fields were calculated using the model with a spectral (bin) microphysics for thermodynamic conditions observed during squall-line formation in the GATE-74 measurement camplaign. (Ferrier and Houze, 1989). FIG. 4 shows the development of secondary clouds due to the convergence of air in the boundary layer caused by cold downdrafts from the primary cloud. It is seen that the squall line forms only in the aerosol-rich air (after Khain et al., 2005). The secondary cloud develops and reaches the stage of squall line only in the case of high aerosol concentration. In clean air, the secondary clouds and downdrafts are weaker and the secondary clouds decay without any significant development.

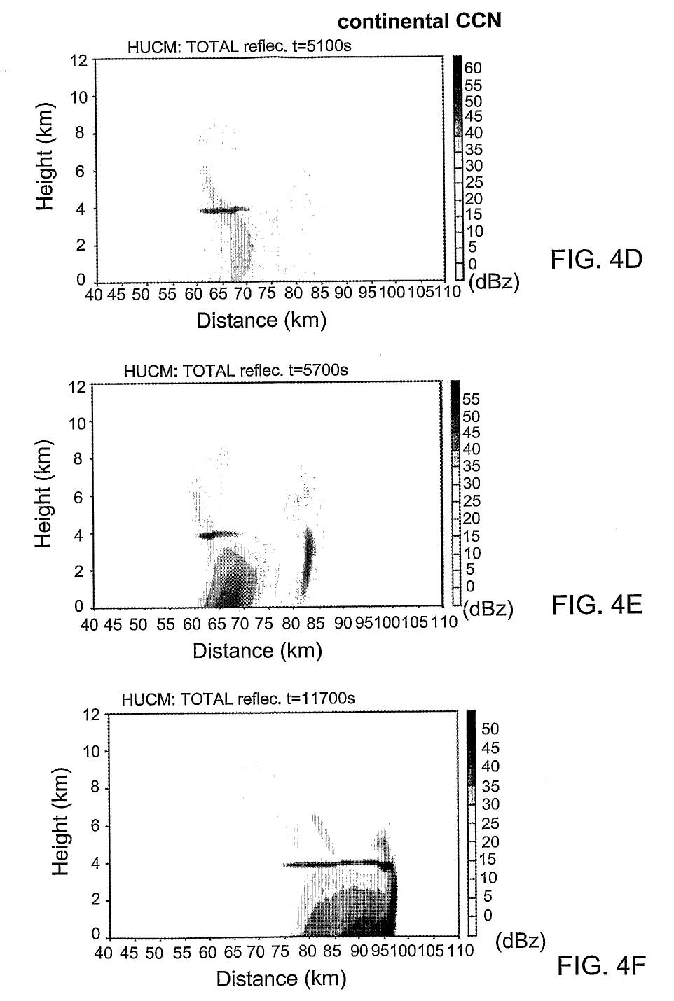

Simulation in which suppression of warm rain was applied showed that the initial result of suppression of warm rain is warming at the upper levels due to the added release of latent heat of freezing and enhancing the updrafts aloft, coupled with low level melting and evaporative cooling. However, about 12 hours after the initial “seeding” (i.e., suppression of warm rain), the upper level warming became limited to a shallow layer above the freezing level and the enhanced updrafts aloft vanished. Yet, the low level cooling did not diminish. The enhanced low level relative humidity implies that this low level cooling occurs due to greater low level evaporation of cloud water that was not precipitated. FIG. 5 shows that suppression of warm rain causes low level cooling causes weakening the storm as measured by the area covered with hurricane force winds (wind speed >32 meter/sec), more so for the greater extent of suppression of warm rain. WR is warm rain everywhere; NWRP is no warm rain in the periphery; NWR is no warm rain everywhere. FIG. 5 also shows a net loss of condensation latent heating, which leads to less buoyant lower tropospheric air and weakening the overall intensity of the tropical cyclone. In addition, the added cloud water further adds to the weight of the air, decreases its buoyancy and tendency to rise and form the storm clouds, in accordance with curve a in FIG. 3).

The potential temperature does not change in the process of evaporation of cloud water. Therefore, this cooler air can still rise in deep convection, especially when initially forced upward at the eye wall. Based on these considerations, it is suggested here that the continuous cooling at the tropical cyclone periphery, especially in the tropical cyclone lowest 3 km, leads to compaction of the tropical cyclone circulation which can be attributed to the lesser tendency of the more stable low level air to rise before reaching the circulation centre. This idea is also supported by the simulation results of Nong and Emanuel (2003), which showed that low level air with enhanced buoyancy tends to rise before reaching the eyewall and initiate the process of an eyewall replacement with a larger eye.

### REFERENCES

Andreae M. O, D. Rosenfeld, P. Artaxo, A. A. Costa, G. P. Frank, K. M. Longo, and M. A. F. Silva-Dias, 2004: Smoking rain clouds over the Amazon. Science, 303, 1337-1342.
Betts, A. K., 1982: Saturation point analysis of moist convective overturning. Journal of the Atmospheric Sciences, 39, 1484-1505.
Black R. J., and J. Hallett, 1986: Observations of the distribution of ice in hurricanes. J. Atmos. Sci., 43, 802-822.
Dusek U. et al., 2006: Size matters more than chemistry for cloud-nucleating ability of aerosol particles. Science, 2 Jun. 2006: Vol. 312. no. 5778, pp. 1375-1378, DOI: 10.1126/science.1125261.
Ferrier, B. S. and Houze, R. A., Jr. 1989 One-dimensional time-dependent modeling of GATE cumulonimbus convection. J. Atmos. Sci., 46, 330-352
Freud E., Daniel Rosenfeld, Meinrat O. Andreae, Alexande A. Costa and Paulo Artaxo, 2005: Observed robust relations between CCN and vertical evolution of cloud drop size distributions in deep convective clouds. Atmos. Chem. Phys. Discuss., 5, 10155-10195. http://www.copernicus.org/EGU/acp/acpd/5/10155/acpd-5-10155.htm
Khain, A. D. Rosenfeld and A. Pokrovsky 2005: Aerosol impact on the dynamics and microphysics of convective clouds. Q. J. Roy. Meteor. Soc. 131, 2639-2663.
Lucas, C, E. J. Zipser, and M. A. LeMone, 1994a: Vertical velocity in oceanic convection off tropical Australia. J. Atmos. Sci., 51, 3183-3193.
Nong, S. and Emanuel K.: A numerical study of the genesis of concentric eyewalls in hurricanes. Q. J. R. Met. Soc., 129, 3323-3338, 2003.
Petersen, W. A., and S. A. Rutledge, 1996: Cloud-to-ground lightning observations from TOGA COARE: Selected results and lightning location algorithms. Mon. Wea. Rev., 124, 602-620.
Rosenfeld D., 1999: TRMM Observed First Direct Evidence of Smoke from Forest Fires Inhibiting Rainfall. Geophysical Research Letters. 26, (20), 3105-3108.
Rosenfeld D., 2006: Aerosols Suppressing Precipitation in the Sierra Nevada: Results of the 2006 Winter Field Campaign. Presented at the Third Climate Change Research Conference, California Energy Commission, Sacramento, Calif., 13-15 Sep. 2006. Presentation available at: http://www.climatechange.ca.gov/events/2006_conference/presentations/2006-09-14/2006-09-14_ROSENFELD.PDF
Rosenfeld D. and I. M. Lensky, 1998: Satellite-based insights into precipitation formation processes in continental and maritime convective clouds. The Bulletin of American Meteorological Society, 79, 2457-2476.
Rosenfeld D. and W. L. Woodley, 2000: Deep Convective Clouds with Sustained Supercooled Liquid Water Down to −37.5° C. Nature, 405, 440-442.
Segal Y., A. Khain, and M. Pinsky and A. Sterkin, 2004: Effects of atmospheric aerosol on precipitation in cumulus clouds as seen from 2000-bin cloud parcel microphysical model: sensitivity study with cloud seeding applications. Quart. J. Roy. Meteor. Soc. 130, 561-582.
Shao X. M. et al., 2005: Katrina and Rita were lit up with lightning. EOS, Vol. 86, No. 42, 18 Oct. 2005.
Willoughby, H. E., D. P. Jorgensen, R. A. Black, and S. L. Rosenthal, 1985: Project STORMFURY, A Scientific Chronicle, 1962-1983, Bull. Amer. Meteor. Soc., 66, 505-514.
Xu, K., and K. A. Emanuel, 1989: Is the tropical atmosphere conditionally unstable? Monthly Weather Review, 117, 1471-1479.
Zipser J., E., and K. R. Lutz, 1994: The vertical profile of radar reflectivity of convective cells: a strong indicator of storm intensity and lightning probability?. Monthly Weather Review, 122, 1751-1759.
Zipser J. E., and M. A. LeMone, 1980: Cumulonimbus vertical velocity events in GATE. Part II: Synthesis and model core structure. J. Atmos. Sci., 37, 2458-2469.
U.S. Pat. No. 5,441,200 to Rovella, II.

1. A method for treating a tropical cyclone, a tropical storm or a tropical depression comprising reducing unloading of cloud parcel water in at least a first portion of the tropical cyclone, tropical storm or a tropical depression.

2. The method according to claim 1 wherein the first portion of the tropical cyclone, tropical storm or tropical depression includes a portion of the tropical cyclone, tropical storm or tropical depression having a wind velocity below 20 meters/sec and below a 0° C. isotherm.

3. The method according to claim 1 wherein the step of reducing unloading of cloud parcel water reduces unloading of cloud parcel water until the cloud parcel reaches an altitude having a predetermined temperature.

4. The method according to claim 3 wherein the predetermined temperature is below 0° C.

5. The method according to claim 4 wherein the predetermined temperature is −5° C.

6. The method according to claim 1 wherein the step of reducing unloading of cloud parcel water comprises seeding the tropical cyclone, tropical storm or tropical depression with cloud condensation nuclei (CCN), the CCN being hygroscopic particles.

7. The method according to claim 6 wherein the CCN are in the form of an aerosol.

8. The method according to claim 7 wherein the aerosol is a sulfur-containing aerosol.

9. The method according to claim 8 wherein the aerosol comprises ammonium sulfate.

10. The method according to claim 6 wherein the concentration of the CCN is at least 1000 CCN cm⁻³ in at least a second portion of the tropical cyclone, tropical storm or tropical depression.

11. The method according to claim 10 wherein the concentration of the CCN is at least 2000 CCN cm⁻³ in at least a third portion of the tropical cyclone, tropical storm or tropical depression.

12. The method according to claim 6 wherein the CCN have a diameter less than 1 micron.

13. The method according to claim 1 wherein the first portion of the tropical cyclone, tropical storm or tropical depression includes at least a portion of peripheral clouds of the tropical cyclone, tropical storm or tropical depression.

14. The method according to claim 6 wherein the CCN are seeded from one or more aircraft.

15. The method according to claim 14 wherein the CCN are smoke formed by combustion of one or more seeding agents in a combustion device mounted on the aircraft.

16. The method according to claim 15 wherein a mass of CCN are released from the one or more aircraft that exceeds a mass of the one or more seeding precursors carried by the aircraft and used to create the seeded CCN, and wherein seeding at least a portion of the tropical cyclone, tropical storm or tropical depression with ice nuclei (IN) is carried out from the one or more aircraft.

17. The method according to claim 1 further comprising seeding at least a portion of the tropical cyclone, tropical storm or tropical depression with ice nuclei (IN).

18. The method according to claim 17 wherein the IN comprises silver iodide based particles.

19. The method according to claim 5 further comprising seeding at least a portion of the tropical cyclone, tropical storm or tropical depression with IN after the cloud parcel reaches an altitude having the predetermined temperature.

20. The method according to claim 19 wherein the IN comprises silver iodide based particles.

21. (canceled)
